(19) United States
(12) Patent Application Publication
(10) Pub. No.: US 2018/0025678 A1
(43) Pub. Date: Jan. 25, 2018

(54) DISPLAY DEVICE AND CONNECTOR FOR A DISPLAY DEVICE

(71) Applicant: Portable Branding (Pty) Ltd., Gauteng (ZA)

(72) Inventor: William Peter Cilliers, Bloemfontein (ZA)

(21) Appl. No.: 15/551,746

(22) PCT Filed: Feb. 18, 2016
(86) PCT No.: PCT/IB2016/050867

§ 371 Date: Aug. 17, 2017

(30) Foreign Application Priority Data
Feb. 18, 2015 (ZA) 2014/06033

(51) Int. Cl. G09F 15/00; G09F 7/18; G09F 17/00

(52) U.S. Cl. CPC G09F 15/0018; G09F 15/0062; G09F 17/00; G09F 7/18; G09F 2007/1804; G09F 7/22

(57) ABSTRACT

This invention relates to a display device (1) and to a connector (10) for the display device (1) and more particularly, but not exclusively to a three-dimensional display device (1) and a connector (10) therefore. A display device (1) includes an anchor means (12) and a display means (2), the anchor means (12) being connected to the display means (2) with a resiliently deformable connector (10).

### FIELD OF THE INVENTION

This invention relates to a display device and to a connector for the display device and more particularly, but not exclusively to a three-dimensional display device and a connector therefore.

### BACKGROUND TO THE INVENTION

Advertisement display devices such as banners and flags are well-known and widely used. In recent years, there has been an increase in the use of three-dimensional outdoor banners such as those depicted below:

A “lantern” banner on the left and an umbrella on the right:

Gazebos, on the left, and 2-D shark fin or surf banners, on the right, are also used to advertise goods and/or services:

The above outdoor display devices have to be anchored properly to ensure that are not blown away or damaged in windy conditions. The umbrella shown above has a heavy foot piece that provides some resistance to being blown over in windy conditions but a strong enough wind may still topple and damage the umbrella, if it is blown over. Even if these display devices are not blown over, and are securely anchored, wind may still damage their structures and the banner material used for the display of advertisement information. If the support structures do not give way in wind, the banner material takes the full force of the wind.

### OBJECT OF THE INVENTION

It is an object of this invention to provide a display device and a connector for a display device which, at least partially, alleviate the above-mentioned difficulty.

### SUMMARY OF THE INVENTION

In accordance with this invention there is provided a display device comprising an anchor means and a display means, the anchor means being connected to the display means with a resiliently deformable connector.

There is provided for the resiliently deformable connector to include a resiliently deformable rubber body.

There is further provided for the rubber body to have a reduced size mid-section.

There is still further provided for the rubber body to be round in cross-section and to have thicker opposite outer sections on opposite sides of its mid-section. Alternatively, the rubber body may be cylindrical having an annular rebate or a number of annular rebates along the length thereof, spaced axially from each other.

There is further provided for the resiliently deformable connector to include a spring element.

The spring element may consist of spring steel or of a number of springs. The springs may be coil springs.

The display means may be a collapsible display means.

There is provided for the display means to include a collapsible support structure for supporting a banner material.

In an alternative embodiment, a permanent support frame may be used to support a flexible banner material.

In yet a further alternative embodiment, the display means may be a rigid display means with or without a support structure.

There is still further provided for the anchor means to anchor the display device to a substrate.

The anchor means may be a spike for use to anchor the display device in soil or in any other suitable substrate.

The anchor means could be concrete, rubber, an umbrella base, a water or sand filled bag or bucket or other receptacle or a combination thereof.

This invention extends to a connector for a display device comprising attachment means for attachment to thereof to an anchor means and to a display means.

These and other features of invention are described in more detail below.

### BRIEF DESCRIPTION OF THE DRAWINGS

One embodiment of the invention is described below by way of example only and with reference to the drawings in which:

FIG. 1 shows a side view of a display device;

FIG. 2 shows a perspective view of a second alternative embodiment of an anchor means or spike for the display device of FIG. 1;

FIG. 3 shows a side view of the display device of FIG. 1 used with the anchor device of FIG. 1 and with a second alternative embodiment of a resiliently deformable connector; and

FIG. 4 shows a perspective view of the resiliently deformable connector of the display device of FIG. 1.

### DETAILED DESCRIPTION OF THE DRAWINGS

With reference to the drawings, in which like features are indicated by like numerals, a display device is generally indicated by reference numeral 1.

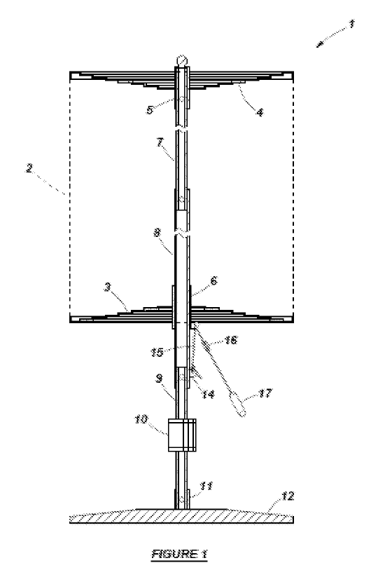

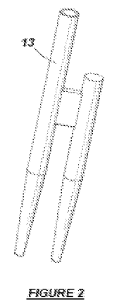

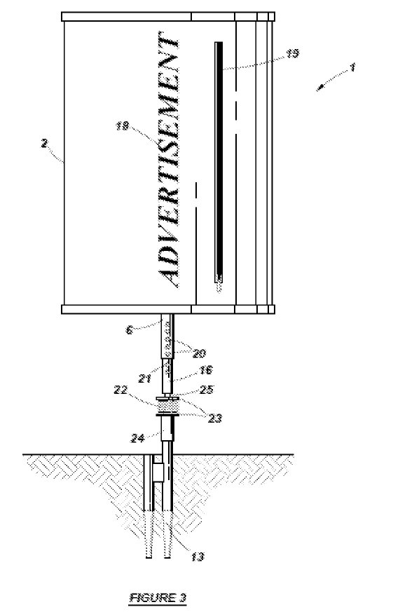

The display device 1 includes an anchor means 13. In the embodiment of FIG. 1, the anchor means is in the form of heavy body of concrete for supporting the display device. It will be appreciated by those skilled in the art, that any other suitably heavy body may be used. Further, alternatively, a spike device 13, as shown in FIG. 2, can be used to secure the display device in the ground, as shown in FIG. 3.

The display device may be anchored using the body of concrete 12 or the spike 13.

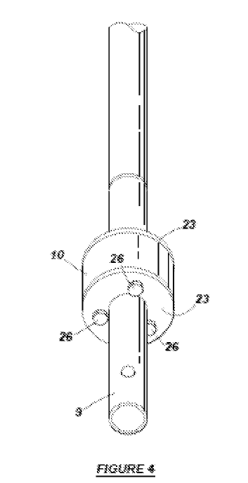

FIG. 4 shows a connector device in accordance with an embodiment.

A pipe section may be inserted into a tubular stub 11 as is shown, for example, on the body of concrete 12. In the embodiment as shown in FIG. 3, a lower pipe section 24 of a connector means locates over an upper pipe section or rod of the spike 13. A connector means connects the anchor means with the display means.

The connector means includes a resiliently deformable section 10 or 22 in the form of a round section of rubber as shown in FIGS. 1 and 4 or in the form of springs 22 as shown in FIG. 3. In the case of the resiliently deformable member 22, in the form of the springs, the springs may take the shape of a number of coil springs or a leaf spring or any other convenient spring.

The rubber section 10 may also have an annular rebate (not shown). Alternatively, it may have a reduced diameter midsection so that the outer ends thereof are thicker than the midsection. Plates 23 in the form of discs are located on the ends of the resiliently deformable member or means 10 or 22. Coaxial tubular rods or pipes in the form of pipes or rods 9, 25 and 24 extend in opposite directions away from the connector means and from the disc plates 23. Nuts and bolts 26 may be provided to secure the discs on either side of the resiliently deformable means (10 or 22).

The display means consists of a number of pipe sections in the form of, for example, pipe sections 7 and 8 connected end to end with opposite ends thereof (of the combined pipe sections or the connected pipe sections) engaging at either opposite ends over an upper end of the connector means and to an upper support disc 4 for supporting a display canvas 2, as is further described below.

A lower disc 3 for supporting a display canvas has a centrally located short pipe section or stub 6 which is slidably movable over pipe section 8, being the lowermost pipe section of the display means. A rope or string 15 is connected to a lug 14 at a lower end of pipe section 8 and passes through a ring at the lower end of the stub 6 from where it passes through a securing means 16 and terminates in a handle 17. By pulling on the handle and thus pulling the string through the ring at the lower end of the stub 6, the disc 3 is pulled operatively downwards. A display canvas 2 in the form of a tubular material section having closed ends is draped over the two disc members (3 and 4). Thus, when tightening the string 15 as described above, the lower disc 3 is moved away from the upper disc 4 to tighten the display canvas 2.

In an alternative embodiment to the string 15 and its associated tightening means, a spring loaded ball and clip configuration may be used as is shown in FIG. 3, to tighten the display canvas 2 between the upper and lower discs, 3 and 4. Spring-loaded balls 21 or, alternatively, holes 21 in the lower pipe 8 may be aligned with holes 20 in the stub section 6 so that the spring-loaded balls 21 or, in the case of item 21 being holes, are aligned so that the balls engage in the holes 20 or a pin may be engaged therein, through holes 20 and 21, once the stub has been sufficiently slidingly moved downwards on the pipe 8.

Advertisement display information 18 may be printed on the display canvas.

An access opening closable with a zip 19 may be provided in the display canvas to allow access to the inner pipes and to selectively connect or disconnect these pipes.

It is envisaged that the display device described herein will be convenient to use in outside conditions especially in windy weather. The display device is furthermore collapsible for ease of transport and storage. The deformable connector will ensure longevity of the display device of both its frame or support structure and banner material. The deformable connector will give way in windy conditions this protecting the display means.

The invention is not limited to the precise details as described herein. For example, instead of using an anchor device in the form of a spike for securing the display device in soil any other anchor means can be used. For example, an anchor means that attaches to a wall of a building or any other structure may be used in the anchor device is certainly not limited to a spike. Furthermore, the discs 3 and 4 can be flat or could be shaped to help shape the display means to any desired shape.

1. A display device comprising an anchor means and a display means, the anchor means being connected to the display means with a resiliently deformable connector.

2. A display device as claimed in claim 1 in which the resiliently deformable connector includes a resiliently deformable rubber body.

3. A display device as claimed in claim 2 in which the rubber body has a reduced size mid-section.

4. A display device as claimed in any one of claim 2 or 3 in which the rubber body is round in cross-section and has thicker or larger diameter opposite outer sections on opposite sides of its smaller diameter mid-section.

5. A display device as claimed in anyone of claim 2 or 3 in which the rubber body is cylindrical having at least one annular rebate along the length thereof.

6. A display device as claimed in claim 1 in which the resiliently deformable connector includes a spring element.

7. A display device as claimed in claim 6 in which the spring element consists of spring steel or of a number of springs.

8. A display device as claimed in claim 7 in which the spring steel or spring or springs is in the form of a coil spring.

9. A display device as claimed in any one of the preceding claims in which the display means is a collapsible display means.

10. A display device as claimed in any one of the preceding claims in which the display means includes a collapsible support structure for supporting a banner material.

11. A display device as claimed in any one of claims 1 to 8 in which the display means includes a permanent support frame to support a flexible banner material.

12. A display device as claimed in any one of claims 1 to 8 in which the display means is a rigid display means with or without a support structure.

13. A display device as claimed in any one of the preceding claims in which the anchor means anchors the display device to a substrate or support.

14. A display device as claimed in claim 13 in which the anchor means is a spike for use to anchor the display device in the ground.

15. A display device as claimed in any one of claims 1 to 13 in which the anchor means is any one or more of the group consisting of a body of concrete, a body of rubber, an umbrella base, a water filled bag, a sand filled bag or container.

16. A connector for a display device comprising attachment means for attachment thereto an anchor means and a display means.
